(19) United States
(12) Patent Application Publication
(10) Pub. No.: US 2026/0095006 A1
(43) Pub. Date: Apr. 2, 2026

(54) QUICK-CONNECT ELECTRICAL OUTLET

(71) Applicant: Michael Donnell, Sandy, UT (US)

(72) Inventor: Michael Donnell, Sandy, UT (US)

(21) Appl. No.: 19/345,810

(22) Filed: Sep. 30, 2025

Related U.S. Application Data
(60) Provisional application No. 63/701,355, filed on Sep. 30, 2024.

(51) Int. Cl. H01R 25/00; H01R 4/40; H01R 13/46; H01R 13/74; H01R 43/20; H01R 105/00; H02G 3/18

(52) U.S. Cl. CPC H01R 25/006; H01R 4/40; H01R 13/465; H01R 13/74; H01R 43/205; H02G 3/18; H01R 2105/00

(57) ABSTRACT

The present disclosure relates to quick-connecting electrical outlets. The quick-connect electrical outlet disclosed herein may have a ground wire, a neutral wire, and a hot wire, that all enter the quick-connect electrical outlet at a common receiver portion that has terminals spaced similarly to the spacing of wires within existing wiring bundles of nonmetallic sheathed bundles. A terminal screw may receive each of the wires. The ground wire, the neutral wire, and the hot wire may be held together by a sheath. A socket may be located on the quick-connect electrical outlet, which will receive an electrical plug into apertures connected to a hot, neutral, and ground wire. Each wire may have a separate indicator. The indicators may be used to inform an installer as to which wire should be installed where.

### CROSS-REFERENCE TO RELATED APPLICATION

This application claims the benefit of U.S. Provisional Application No. 63/701,355, filed Sep. 30, 2024, the disclosure of which is incorporated herein by reference in its entirety.

### TECHNICAL FIELD

The present disclosure generally relates to electrical outlets. More particularly, embodiments of the present disclosure relate to quick-connecting electrical outlets.

### BACKGROUND

One of the most common causes of electrical fires is faulty electrical outlets. As outlets age, the wires connecting the outlet to the electric panel can become loose and cause electrical short circuits, arcing, and heating. The connections that are used on the front of the outlet to plug in an appliance also become loose and do not hold the plug in as tightly. As a result, the outlet should be replaced. Professional electricians are required to install and replace thousands of electrical outlets and switches daily, and the process requires a lot of time and close attention to the “hot”, “neutral”, and “ground” wiring colors to ensure proper and safe installation. Mistakes are easily made in this process, leading to faulty outlets at best and electrical fires at worst.

Junction boxes and wall-boxes are full of wires that are typically unlabeled and become cluttered and difficult to manage. When an electrician rewires an outlet for an upgrade or a replacement, it can take a significant amount of time to trace the individual wires. Adding a place to encourage a labeling system would speed up future work and accuracy as well as minimize the potential to have several “hot” wires coming to the same outlet.

In existing outlets and switches, the neutral wire (typically indicated with white insulation) in wall-boxes is stripped, and the line-in and line-out wires are connected with a wire-nut. When there is only one line-out wire, the connections are relatively simple and do not take up much space in a wall-box. However, if there are multiple switches in the wall-box the neutral connections wired together can be difficult to keep secured together with a large wire-nut. The ground wires have a similar problem because they connect to each individual switch as well as the line-out wire leaving the wall-box.

There can be several methods of securing connections to the wire within an outlet or switch wall-box. The side-wire method, in which wires are coupled to electrical connections of the switch or outlet by screws on the side thereof, has been around the longest. It is easy to wire but leaves room for mistakes, such as too much wire sheathing being removed and creating a potential for shorts with the exposed wire to either other wires in the box or, for metal boxes, to the box itself. Conversely, if not enough wire sheathing is removed, the sheath can get in the way of the electrical connection around the terminal and cause a bad connection and a loose wire.

Push-wiring is another method which requires the user to strip the wire to a set length and then push the wire into the back of the outlet. To undo the connection the user can push in on a release tab. This method is very fast to install but does not make a very good connection and is limited in the gauge of wire that it is able to accept.

The last method is back-wiring. This requires the user to strip the wire to a set length, insert it into the back of the outlet and use a screw and clamp method to tighten and loosen the wire. The connection is very strong and reliable; it takes slightly longer than push-wiring but is faster than side-wire, with the best connection and easiest rework ability.

All of these current connection methods require that the electrical cable, such as NM-B, UF-B or other cable holding multiple insulated wires, have the outer cable stripped back to expose the individual wires, which are then splayed apart and stripped of insulation a sufficient distance to allow the connections to be made. This can result in a spread of wires with exposed portions that can cause shorts.

Therefore, there exists a need to simplify electric outlets, or create a switch quick-connect wiring method that will save time, increase safety, and minimize errors.

### SUMMARY

Disclosed herein is an electrical outlet or switch, quick-connect wiring method that will save time, increase safety, and minimize errors. By changing where the wires connect to the back of the outlet or switch, and minimizing the distance between the hot, neutral, and ground wire, the new outlets, switches, light fixtures, and junction boxes will be able to be installed faster, and allow an installer to keep better track of which wire is the line in wire, and remove the wire bundles inside wall boxes caused by the current wire connection method. It will also make it easier to install or replace the outlet/switch into the wall box.

In one aspect, the quick-connect electrical outlet can receive a ground wire, a neutral wire, and a hot wire. The quick-connect electrical outlet can receive all of these wires on a side that has apertures spaced at the same distance and order as a typical sheathed wire. A terminal screw may receive each of the wires. The ground wire, the neutral wire, and the hot wire may be held together by a sheath. A socket may be located on the quick-connect electrical outlet, which will receive an electrical plug into apertures connected to a hot, neutral, and ground wire. Each wire may have a separate indicator. The indicators may be used to inform an installer as to which wire should be installed where. The indicators may be identified with a color, with a name, or with a symbol. In each embodiment, the indicator will be present for the ground wire, the neutral wire, and the hot wire. A mounting bracket may be attached on either side of the quick-connect electrical outlet, to allow it to be mounted to a wall box or surface.

According to a second aspect, a method of installing the quick-connect electrical outlet disclosed herein involves each of the wires going into the back of the new outlet or switch in an easier-to-reach location on the outlet or switch than is currently used. The wires are not splayed to reach both sides of the outlet or switch and the ground wire will not be loose in the wall box with more of the ground being able to remain sheathed. The method allows for less outer sheathing needing to be removed which may minimize the chance of a ground wire accidentally touching the live sides of the outlet causing a short and potential fire.

According to a third aspect, a three-way switch or four-way switch involve several different orders that the line-in wire, switches, and lights may be in. The traveler wires between the switches will be marked with indicators. By creating a system that allows the switches to be labeled by the installer using indicators, rewiring is simplified and made safer for a future upgrade or replacement. The system also facilitates labeling and organization within the junction box.

According to a fourth aspect, routing the hot wire, the ground wire, and the neutral wire into the outlet and switches from the same, labeled location reduces the chances of failure modes such as a loose ground wire touching an exposed hot wire or neutral wire of an outlet. The devices and methods disclosed herein also minimize or prevent the need for wire nuts being used in junction boxes including wall boxes. This method may keep the label more clear for “in” and “out” in junction boxes, where an installer is able to label where the wire is intended to go, i.e. “out—bedroom” or “out—south wall”.

### BRIEF DESCRIPTION OF THE DRAWINGS

It will be appreciated by those of ordinary skill in the art that the various drawings are for illustrative purposes only. The nature of the present disclosure, as well as other varying embodiments, may be more clearly understood by reference to the following detailed description, and to the drawings, as well as to the appended claims.

FIG. 1A is a conceptual front view of a quick-connect electrical outlet.

FIG. 1B is a conceptual back view of an alternative embodiment of a quick-connect electrical outlet.

FIG. 2A is a schematic view of the quick-connect electrical outlet of FIG. 1A, depicting wiring tracks for both a hot wire and a neutral wire.

FIG. 2B is a schematic view of the quick-connect electrical outlet of FIG. 1A, depicting a wiring track for a ground wire.

FIG. 3 is a partial side cross-sectional view of an embodiment of a connection method for the quick-connect electrical outlet of either of FIG. 1A or 1B.

FIG. 4 is a partial side cross-sectional view of an embodiment of a connection mechanism using one screw and holding three different wires in the quick-connect electrical outlet of either of FIG. 1A or 1B.

FIG. 5 is an orthogonal view of an embodiment of a connection method for back-wiring with one screw per wire for the quick-connect electrical outlet of either of FIG. 1A or 1B.

FIG. 6 is a view of an embodiment of a three-way switch according to the present disclosure.

FIG. 7 is a schematic view of a wiring arrangement between a first wall switch and a second wall switch.

FIG. 8 is a top view of a junction box, with an exposed side view.

FIGS. 9A and 9B are schematic diagrams of two three-way switches connected to a load, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present disclosure relates to a quick-connect electrical outlet and methods of use. The quick-connect electrical outlet may be designed to provide a more time- and cost-effective installation of electrical outlets, as well as eliminate or reduce potential safety hazards and concerns. The quick-connect electrical outlet disclosed herein may also aid in reducing errors, by changing where the wires connect to the back of the outlet or switch, and reducing the distance between the hot, neutral, and ground wires. This makes each of the wires easier to install, keep track of, and removes the wire bundles that are generally inside of wall boxes as used by current outlets and wire connection methods.

A method of installing the quick-connect electrical outlet disclosed herein includes routing each of the wires (ground, neutral, hot, and any travelers) into the back or side of the new outlet or switch substantially as a single bundle of wires extending in parallel. This means that the wires will not be splayed in order to reach both sides of the outlet or switch, and the ground wire will not be loose. Less of the outer sheathing of the wire bundle will need to be removed, which aids in minimizing the changes of a ground wire touching the live sides of the outlet, causing a short, and potentially, a fire.

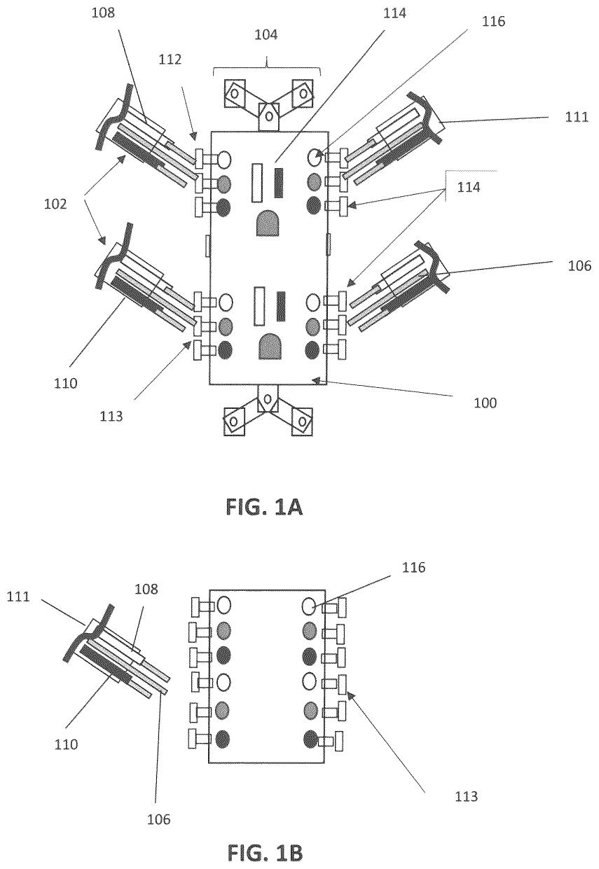

Referring now to the drawings, FIG. 1A is a conceptual front view of a quick-connect electrical outlet 100. The quick connect electrical outlet 100 is simplified by having a ground wire 106, a neutral wire 108, and a hot wire 110 within a common wire bundle 111 all enter the quick-connect electrical outlet 100 at the same receiver portion 113. The wires (106, 108, 110) within a single bundle need not be distributed between multiple receiver portions 113. Although four wire bundles 111 are shown in FIG. 1A approaching each of four receive portions 113, it should be understood that in common wiring schemes only one wiring bundle 111 will typically be used at a time.

It will be appreciated that the wire bundles 111 may be any cable containing multiple separate current conducting wires, including non-metallic cable, such as NM-B with a thermoplastic sheathing surrounding thermoplastic insulated wires, underground feeder cable, such as UF-B cable, with the wires embedded as a group in solid thermoplastic, AC or BX armored cable, of metal-clad cable, or other cable types. Standards for different cable types put forth by the National Electrical Code (NEC) include NFPA 70, 2023, 3 Wiring Methods and Materials, 334 Nonmetallic-Sheathed Cable: Types NM and NMC and NFPA 70, 2023, 3 Wiring Methods and Materials, 340 Underground Feeder and Branch-Circuit Cable: Type UF, the contents of which are incorporated by reference herein.

Because the wires (106, 108, 110) are arranged in the same order and spacing as the corresponding receiving features on the quick-connect electrical outlet 100, very little of the insulating jacket or sheath 102 of the wire bundle need be removed to form a connection.

Each one of the terminal screws 112 may receive one of the ground wire 106, neutral wire 108, and hot wire 110. There may be an individual terminal screw 112 for each wire listed, among others (such as travelers) described in more detail below. The ground wire 106, the neutral wire 108, and the hot wire 110 may be held together by a sheath 102. Located on the front of the quick-connect electrical outlet 100 may be a socket 114, which will receive an electrical plug into apertures electrically connected to the hot, neutral, and ground wires (110, 108, and 106, respectively).

Although shown as terminal screws 112, receiver section 113 could include any of a variety of other known wire receiver elements, such as push-pin type wire receivers or back-wire type receivers. In such embodiments, the wire can be stripped a small amount, the sheath 102 cut back only slightly, and the entire wire bundle 111 can be pushed into the device rather than pushing in each splayed wire individually. It will be appreciated that the size of the receiver portions 113 may correspond to the gauge of the wire to be connected thereto by insertion therein.

Each wire may have a separate indicator 116. The indicator 116 may be used to inform an installer as to which wire should be installed where. The indicator 116 may be identified with a color, or with a symbol, or with the wire's name written out (i.e., ′hot), or some combination. In each embodiment, the indicator 116 will be present for the ground wire 106, the neutral wire 108, and the hot wire 110. To mount the quick-connect electrical outlet 100 to a wall or surface, a mounting bracket 104 may be attached on either end of the quick-connect electrical outlet 100. Although the indicators 116 are shown on the front face of the device in FIG. 1A (that is, the face on which the socket 114 is visible), it should be understood that in other embodiments the indicators 116 can be positioned on the side of the device, on the back of the device, or even on the terminal screws 112 themselves, or in some other position that will guide the installer on proper positioning of the wires while making the indicators 116 visible to a user after installation.

In embodiments, and as seen in FIG. 1B, rather than having multiple separate receiver portions 113 that each have a number of terminal screws 112 corresponding to the anticipated wiring, the quick-connect electrical outlet 100 can have omnibus receiver portions 113 that each include a plurality of hot, neutral, and ground (106, 108, 110) wire receiving regions. The quick-connect electrical outlet 100 the outlet may have a repeating series of receivers 113, i.e., 1-ground, 2-hot, 3-neutral, 4-ground, 5-hot, 6-neutral, up to “n” terminals 112.

In the embodiment shown in FIG. 1B, because of the repeating pattern of hot, neutral, and ground terminal screws 112, no matter the order of the wires (106, 108, 110) when the sheath 102 is removed, each of the wires (106, 108, 110), will have an appropriate terminal 112 within the receiver portion 113 such that they can be inserted straight rather than being splayed. In one example, if the order of wires within the sheath 111 is ground-hot-neutral, the wires (106, 108, 110) would be inserted from second to top, third to top, and fourth to top on the receiver portion 113 of FIG. 1B. In another example, if the order is hot-neutral-ground, the wires (106, 108, 110) would be inserted in the order third from top, fourth from top, and fifth from top on the receiver portion 113 shown in FIG. 1B. In another example, if the order is neutral-ground-hot, the wires (106, 108, 110) would be inserted flipped over, running fourth from top, third from top, and second from top, respectively, on the receiver portion 113. In another example, if the order is neutral-ground-hot, the bundle of wires 111 would be rotated in either of the top three terminals 112 or the bottom three terminals on the receiver portion 113.

The positions on the receiver portion 113 may not be numbered in embodiments, but the sequence of repeating wire receiving regions would operate according to principles outlined in the embodiments described. Additionally or alternatively, the terminals 112 could run horizontally rather than vertically (as described with respect to some embodiments below) or could be arranged in a matrix or grid, in different embodiments.

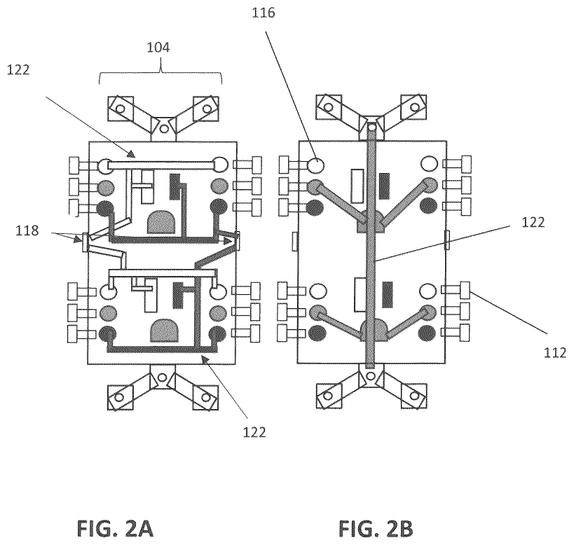

The quick-connect electrical outlet 100 may have a wiring schematic as depicted in the diagram of FIGS. 2A and 2B. An installer will only have to strip wires to a correct length and insert color to color (or color to symbol, or color to printed name, i.e., “hot”). The color or symbol of the indicator 116 and label will be shown on back of the quick-connect electrical outlet 100 to make it easier to install the quick-connect electrical outlet 100. As shown in FIGS. 2A and 2B, the device includes internal circuitry that puts all of the terminals 112 associated with the same function (e.g., all “hot” terminals 112 indicated with the black indicator in FIGS. 1A and 1B) at the same voltage. In some embodiments it may be beneficial to incorporate features to prevent the other exposed terminals 112 that are not connected to the wire bundle 111 from being live and causing injury. This safety feature could include a ground-fault interrupt (GFCI) feature, a circuit breaking system such as a fuse, or a requirement that the terminal screw 112 be driven in to form an electrical connection with the remainder of the terminals 112 of its same type, or some other like feature.

In one embodiment, the ground wire 106, the neutral wire 108, and the hot wire 110 may use symbols rather than colors for the indicator 116. Using colors, the indicator 116 for the ground wire 106 may be green, the indicator 116 for the neutral wire 108 may be white, and the indicator 116 for the hot wire 110 may be black. Using symbols for the indicator 116, the ground wire 106 may use the [symbol] symbol as an indicator 116, the neutral wire 108 may use the − symbol as the indicator 116, and the hot wire 110 may use the + symbol as the indicator 116. Using names for the indicator 116, the ground wire 106 would have “ground” printed next to it as indicator 116, the neutral wire 108 would have “neutral” printed next to it as indicator 116, and the hot wire 110 may have “hot” printed next to it as the indicator 116. In some embodiments depicted in the figures, four wires are shown for illustrative purposes. The quick-connect electrical outlet 100 may have one line in, and three lines out to allow it to be split into an upper and lower half. This arrangement would be advantageous for outlets such as under-sink outlets, where a top half of the outlet is wired for a dishwasher or similar appliance, and the lower half is switched for a garbage disposal.

FIGS. 2A and 2B are schematic views of the quick-connect electrical outlet of FIG. 1A, depicting wiring tracks for both a hot wire and a neutral wire (2A), as well as a wiring track for a ground wire (2B). A fixed electrical track 122 may be used for wiring inside the outlet and may be of sufficient ampacity to ensure that the electrical current is able to be carried by the largest gauge wire that fits will be handled safely. The fixed electrical track 122 runs through the inside of the quick-connect electrical outlet 100 connecting all of the hot wires 110 to the indicator 116 for the hot wire 110, the neutral wires 108 to the indicator 116 for the neutral wire 108, and the ground wires 106 to the indicator 116 of the ground wire 106. The ground wire 106 may also run externally and connect to the mounting bracket 104 to allow the wall box, or the cover plate to connect to the ground wire 106 as well.

In an alternative embodiment, terminals could be dynamically wired. That is, there may be a number of terminals corresponding to the expected input wire (e.g., three terminals 112 for a standard switch or outlet, and four terminals 112 for a three-way or four-way switch). A toggle switch or other feature can be used by an installer to identify what type of wire is inserted in each terminal switch 112. The terminals 112 can be spaced similarly to the spacing shown in FIGS. 1A and 1B, corresponding to the standard spacing of wires within a wire bundle sheath 111. The input mechanism could be, for example, a rotatable dial or slider that has indicators 116 that can be lined up to the terminals 112 and, when lined up, properly connect each of the hot, neutral, and ground (and any travelers) within the switch or outlet.

To separately wire the top and bottom portions of an outlet, as shown in FIG. 2A, the hot wire 110 and the neutral wire 108 will travel through a “breakaway tab” 118 that is designed to come off with sufficient flexing (like bending a paperclip too many times and it breaks) or a pulling force. When the breakaway tab 118 is removed, the connection between a top and a bottom section of the quick-connect electrical outlet 100 is separated. This allows for the top outlet to be hard wired in and the bottom outlet to be connected to a switch, or vice versa. However, the ground wire 106 remains connected and is connected to the mounting bracket 104 to ensure that a metal wall box or outlet cover plate connects to the ground wire 106.

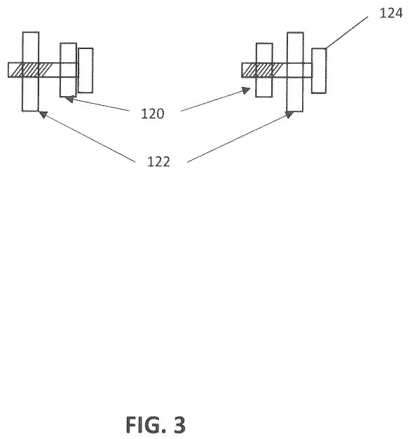

FIG. 3 is a partial side cross-sectional view of an embodiment of a terminal for the quick-connect electrical outlet 100 of FIGS. 1A and 1B. A feature of the quick-connect electrical outlet 100 involves having a fixed electrical track 122 (FIG. 2B) between each of the terminals of a given type for ease of installation, and for safety purposes. A wire can be inserted between an exposed portion of the fixed electrical track 122 and a connecting nut 120. The connecting nut 120 can be pushed in to tighten the wires as the screw 124 is tightened. This connection mechanism is referred to as back-wiring.

There are two versions of back-wiring for tightening around the wire. The first is that the connecting nut 120 is pushed in as the screw 124 is tightened, as shown in FIG. 3. The second is where the connecting nut 120 is pulled in as the screw 124 is tightened. The pulled in method removes the ability to side-wire. It also minimizes the ability for the side screws to be pushed out and potentially connect with the loose ground wires. The threads in FIG. 3 depict which connection is threaded. The unthreaded track or connecting nut 120 may have a hole that is not threaded to allow the screw 124 to pass through. Either could be used for the quick-connect electrical outlet 100 installation.

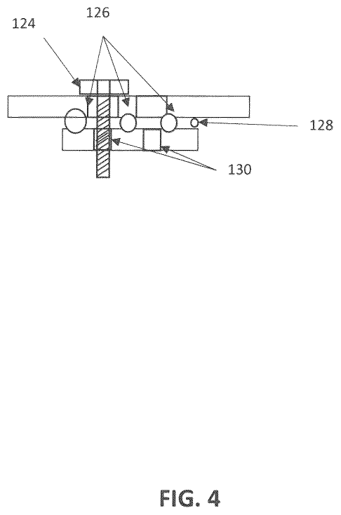

FIG. 4 is a partial side cross-sectional view of an embodiment of a connection mechanism using one screw and holding three different wires in the quick-connect electrical outlet of FIGS. 1A and 1B. FIG. 4 shows a back-wire system where the three wires are clamped down by a single screw 124. The view of FIG. 4 shows a channel 126, which facilitates getting a tight grip on a wire. A pivot point/space 128 may be used in the channel 126. Insulation 130 may be present on either side of the channel to ensure that the wire is protected.

The quick-connect electrical outlet 100 may have a screw 124 for the wire connections and could be on any of the sides or the back of the quick-connect electrical outlet 100. Inserting the ground wire 106 into the quick-connect electrical outlet 100 makes the system shown in FIG. 4 safer than conventional wall boxes, in which the ground wires are twisted together and tucked in the back of the wall box. This also makes it safer for the installer to touch the sides and pull out the quick-connect electrical outlet 100 in case the outlet is energized potentially erroneously from multiple sources. The breakaway tabs 118 as illustrated in FIG. 2A or other isolation features described with respect to that drawing would mitigate the potential safety issues of touching from the sides. In embodiments, the breakaway tab 118 may either be a separate outlet plug made that is specifically designed for the quick-connect electrical outlet 100 or continue to have the breakaway tab 118 be on the sides. The benefit of having the breakaway tab on the sides, is that is electricians are already expecting them to work and there are outlet covers that have LED night lights and other cover face plates that rely on being able to connect to the breakaway tabs.

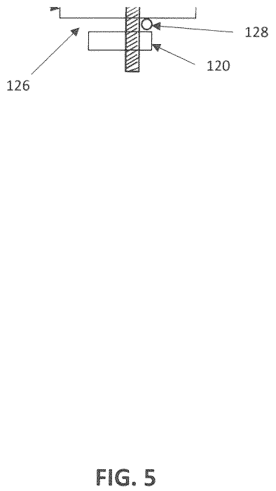

FIG. 5 is an orthogonal view of an embodiment of a connection terminal for back-wiring with one screw per wire for the quick-connect electrical outlet 100 of FIG. 1, where the screw 124 may tightened over a wire. The wire may be any of one the wires (106, 108, 110) discussed above. The embodiment depicted in FIG. 5 includes a nut 120, a conductor 132, and a pivot point 128 for the connecting nut 120. Each wire would be secured separately with a strong connection. For the sake of simplicity, one screw 124 is shown in FIG. 5, however three of the screws 124 would be necessary in an embodiment with one of each of the wires for the hot wire 110, the neutral wire 108, and the ground wire 106. In additional embodiments, more wires may be used, which would include a corresponding tightening screw 124 for the back-wiring method depicted in FIG. 5.

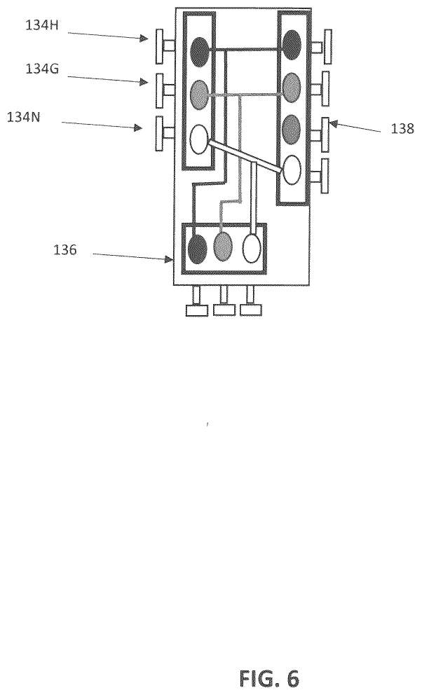

FIG. 6 depicts a view of an embodiment of a three-way switch according to the present disclosure. The electrical load that is powered is typically wired between two three-way switches. Three-way switches, as shown in FIG. 6, typically have a terminal screw for each of the hot, neutral, and ground wires (shown here as 134H, 134N, and 134G, respectively) as described with respect to FIGS. 1-5, as well as a terminal screw for a traveler wire 138. Three-way switches have a line in (connected to the terminal screw 134H) that is for the hot wire 110, a terminal screw (134N) for the neutral wire 108, and a terminal screw (134G) for the ground wire 106. In embodiments, there are several variations of how the switches are wired. In one example, the switch could be wired to be load—switch—switch, or switch—load—switch, or switch—switch-load. The wire connections that go to the light 136 are near the bottom of the switch, and the traveler wires 138 that go out to the other three-way switch, are adjacent to the line in wires (134H, 134N, 134G). The wires traveling between each of the switches may have an extra wire that is used as a “traveler” that allows the switches to turn the system on and off, which can be connected to traveler terminal screw 138. This would allow every wire (106, 108, 110 as shown above, as well as a traveler) to plug into the back of the switch and not have wire nuts in the junction boxes.

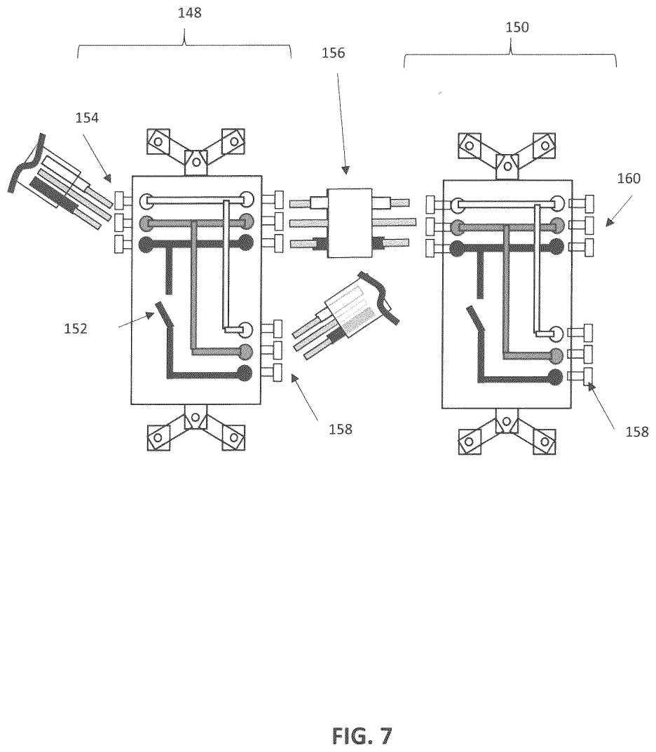

FIG. 7 is a schematic view of a wiring arrangement between a first wall switch and a second wall switch. A first wall switch 148 may include a terminal screw for a line in 154, a switch 152, a terminal screw for a line-out 158, and a pass-through wire 156. The pass-through wire 156 connects the first wall switch 148 to a second wall switch 150. The second wall switch 150 also has the terminal screw for the line-out 158 and may optionally include a terminal screw for a powered line out 160.

In a junction box such as a wall box, there can be multiple switches and outlets. Many outlets and switches will have both a line-in and a line-out. In embodiments, the loads may have an additional line out that connects to a passthrough power line and that does not have a disconnect. The passthrough becomes a line out from the switch or outlet to become a line in for the next switch/outlet in either a load, another switch or outlet in the same junction box, or a switch or outlet in another junction box.

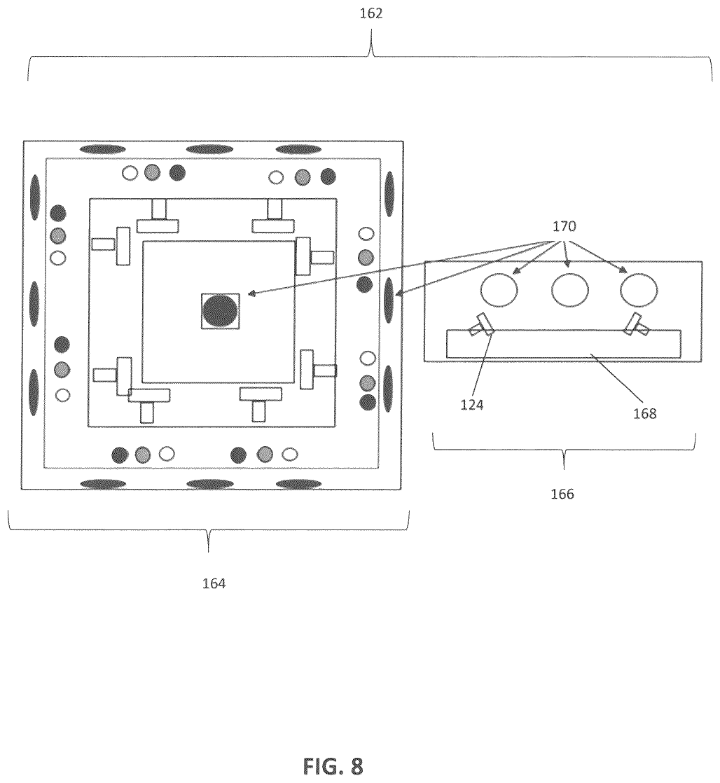

FIG. 8 is a top view of a junction box, with an exposed side view on the right-hand side of the drawing. A junction box 162 may be used to facilitate a line-in wire supplies powering one or more line-out wires. The junction box 162 may have a top 164, and one or more sides 166 of the junction box 162. The top 164 of the junction box 162, and the side 166 may have one or more punchout holes 170 for wires. Additionally, the side 166 of the junction box 162 may have a plate 168 for junction wires. Inside the plate would be one or more tracks that connect each wire together. The one or more punchout holes 170 may have grommets installed at standard sizes to allow wires to come with a connection to a strain relief or conduit connector. This allows for a line in with a hot, neutral, and ground wire (106, 108, 110) to the plate in the quick connect method, and makes it easier to separate one wire out to be reworked, creates quicker installation and removal, and less of a chance of a wire nut coming loose. The one or more punchout holes 170 in the center of the top 164 of the junction box 164 allow for wires coming from the back of the junction box 162. A screw 124 may be used to connect wires to the plate 168 of the side 166 of the junction box 166. The screw 124 may be at a downward angle to allow a screwdriver to tighten the back-wire screw 124 inside of the plate 168. The junction box 162 is used to split power to several outlets or as a place to splice together wires for lengthening. Generally, it is difficult to tell which wire is the line-in and where the line-out wires are intended to go. This structure for wiring a junction box 162 would allow for the installer to denote where the wire comes from or is going.

In one embodiment, the quick-connect outlet 100 may have indentations for uneven sheathing. The wiring on the sides of the outlet/switch have the potential to not be all at the same height. Meaning, the hot wire 110 and the ground wire 106 could have their sheath partially inserted into an indentation so that there is less chance of a short. This would largely minimize the ability of the ground wire 106 to accidentally touch a live wire in the wall box. Stripping the wire sheath and outer sheath to the correct length is possible using a wire stripper. A specialized wire stripper could be used that removes a suitable quantity of the outer sheath as well as the individual wire sheathing to be used in the receptacles described herein. The stripper could have a cutter with a large aperture for the outer sheath, and three smaller-aperture cutters for the individual wires therein. With a single movement, the stripper could then remove a sufficient (but not excessive) amount of the sheath and the individual wire insulation.

The quick-connect electric outlet 100 may also have safety screw cover tabs. The sides of electrical outlets have screw connectors that are used to connect the wires to the outlet or switch. Including a cover that is able to be flipped up after installing the outlet would minimize the ability touching the side of the outlet if the cover is removed or when pulling the outlet out of the wall. By having a cover tab, the likelihood of a loose wire or an installers finger touching the hot wire 110 or neutral wire 108 terminal is minimized. The breakaway tab 118 could be covered if not being used and the screw cover would be able to be removed in the cases where the breakaway tab 118 would be used as an electrical connection i.e., for night light cover plates. The cover plates could be used for a side-wire or back-wire connection method. In embodiments, each in connection or out connection would have its own cover tab.

In assembly, the quick connect electrical outlet 100 may have a sheath 102 that covers the ground wire 106, the neutral wire 108, and the hot wire 110. Each wire may connect to a terminal screw 112. The ground wire 106, the neutral wire 108, and the hot wire 110 may each enter from the back side of the quick connect electrical outlet 100. The quick connect electrical outlet 100 may have a mounting bracket 104 to allow the quick connect electrical outlet to be attached to a wall or another surface.

A ground wire 106, a neutral wire 108, and a hot wire 110 can all enter the quick-connect electrical outlet 100 on one side. The terminal screw 112 may receive each of the ground wire 106, neutral wire 108, and hot wire 110. There may be an individual terminal screw 112 for each wire listed. The ground wire 106, the neutral wire 108, and the hot wire 110 may be held together by a sheath 102. Located on the quick-connect electrical outlet 100 may be a socket 114, which will receive an electrical plug into apertures connected to a hot, neutral, and ground wire. Each wire may have a separate indicator 116. The indicator 116 may be used to inform an installer as to which wire should be installed where. The indicator 116 may be identified with a color, or with a symbol, or name. In each embodiment, the indicator 116 will be present for the ground wire 106, the neutral wire 108, and the hot wire 110. To mount the quick-connect electrical outlet 100 to a wall or surface, a mounting bracket 104 may be attached on either end of the quick-connect electrical outlet 100.

In use, a method of installing the quick-connect electrical outlet 100 disclosed herein involves each of the wires (ground 106, neutral 108, and hot 110), entering through the back of the new outlet or switch. This means that each of the wires will not be splayed in order to reach both sides of the outlet or switch, and the ground wire 106 will not be loose. This method also requires less of the outer sheathing needing to be removed, which aids in minimizing the chances of a ground wire 106 touching the live sides of the quick-connect electrical outlet 100, causing a short, and potentially, a fire.

Many existing outlets may have a GFCI (ground fault circuit interrupter) protection system, and already have enough space to have conductors placed internally and the new wiring schematic added of the quick connect electrical outlet 100. The quick-connect electrical outlet disclosed herein is more likely to ensure the ground wire 106 is wired correctly. Further, because all wires enter through designated positions on the back of the quick-connect electrical outlet 100, it is easier to connect to the system and ensure that the line-in wire is placed correctly. This would also be true of outlets that have a timing switch, Universal Serial Bus (USB) power supply or other connections, displays on the front of the outlet. On existing outlets, there is the possibility of the top and bottom outlet plug being wired to different circuits. This allows for one outlet to be permanently powered while the other is switched.

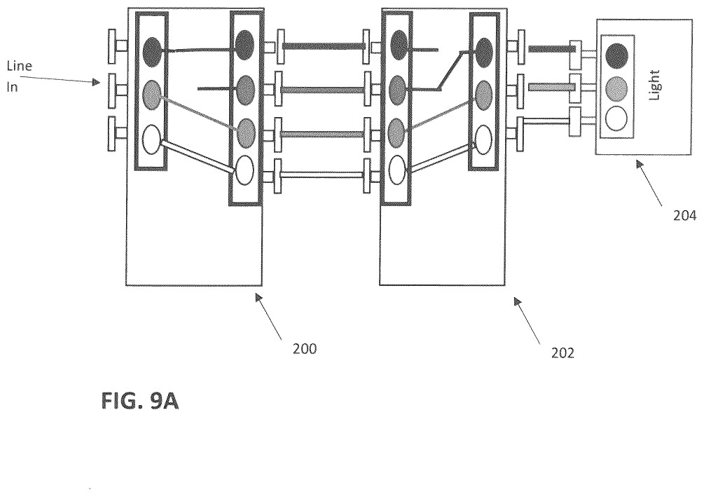

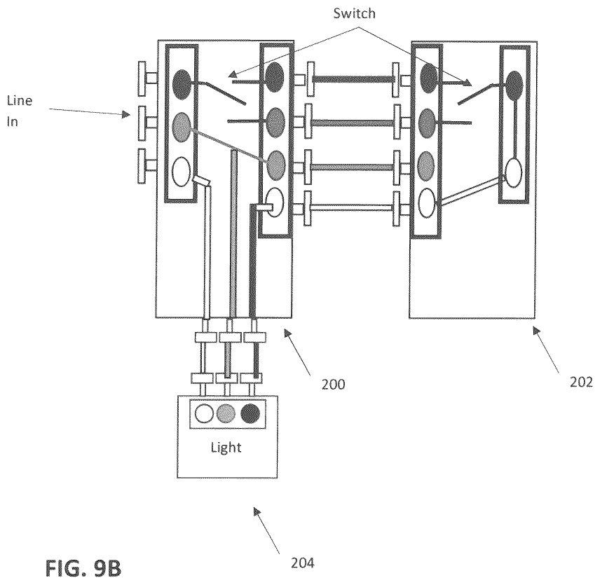

FIGS. 9A and 9B show schematic diagrams for wiring of two three-way switches (200 and 202, respectively) and a load (in this case, a light 204). The wiring of each of the three-way switches is substantially as described above with respect to the other drawings, such as FIG. 6. It should be understood that in embodiments multiple three-way switches (e.g., 200 and 202) may be packaged or sold together as a kit, as they will be used in combination in many electrical installations.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Any incorporation by reference of documents above is limited such that no subject matter is incorporated that is contrary to the explicit disclosure herein.

Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

What is claimed is:

1. A quick-connect electrical outlet for an electrical fixture, comprising:
at least a first plurality of connection apertures disposed on one side of the electrical fixture at a first position, each aperture of the first plurality sized and configured to receive a single stripped wire from a sheathed cable,
the number of apertures in the first plurality corresponding to the number of wires in the sheathed cable and positioned such that they are spaced apart from one another to correspond to the position of individual wires in the sheathed cable, such that the stripped individual wires may be inserted without splaying;
at least one terminal screw for securing an inserted wire in an aperture of the first plurality, such that inserted wire is retained in the aperture in conductive contact with an electrical track in the electrical fixture; and
a plurality of separate indicators disposed on the electrical fixture to identify the individual apertures of the first plurality of connection apertures and designate which individual wire from the sheathed cable should be inserted into the identified individual aperture.

2. The quick-connect electrical outlet for an electrical fixture of claim 1, wherein the sheathed cable is NM-B or UF-B.

3. The quick-connect electrical outlet for an electrical fixture of claim 1, wherein the plurality of separate indicators comprises three indicators identifying hot, neutral and ground.

4. The quick-connect electrical outlet for an electrical fixture of claim 1, wherein the at least one terminal screw comprises a single screw that actuates a clamp on a pivot point to secure the plurality of inserted wires in the least first plurality of apertures.

5. The quick-connect electrical outlet for an electrical fixture of claim 1, wherein the at least one terminal screw comprises a plurality of screws, each screw of the plurality associated with a single aperture of the at least one plurality of apertures.

6. The quick-connect electrical outlet for an electrical fixture of claim 5, further comprising a separate connection nut in each single aperture connected to it corresponding terminal screw, such that actuation of each terminal screw causes the corresponding connection nut to clamp the inserted wire in the aperture.

7. An electrical fixture with quick-connect electrical outlets, comprising
a body;
at least a first plurality of connection apertures disposed on one side of the body at a first position, each aperture of the first plurality sized and configured to receive a single stripped wire from a sheathed cable,
the number of apertures in the first plurality corresponding to the number of wires in the sheathed cable and positioned such that they are spaced apart from one another to correspond to the position of individual wires in the sheathed cable, such that the stripped individual wires may be inserted without splaying;
at least one terminal screw for securing an inserted wire in an aperture of the first plurality, such that inserted wire is retained in the aperture in conductive contact with an electrical track in the body; and
a plurality of separate indicators disposed on the body to identify the individual apertures of the first plurality of connection apertures and designate which individual wire from the sheathed cable should be inserted into the identified individual aperture.

8. The electrical fixture of claim 7, further comprising
at least a second plurality of connection apertures disposed on one side of the body at a second position, each aperture of the first plurality sized and configured to receive a single stripped wire from a sheathed cable,
the number of apertures in the second plurality corresponding to the number of wires in the sheathed cable and positioned such that they are spaced apart from one another to correspond to the position of individual wires in the sheathed cable,
such that the stripped individual wires may be inserted without splaying;
at least one second plurality terminal screw for securing an inserted wire in an aperture of the second plurality, such that inserted wire is retained in the aperture in conductive contact with an electrical track in the body; and
a plurality of separate indicators disposed on the body to identify the individual apertures of the second plurality of connection apertures and designate which individual wire from the sheathed cable should be inserted into the identified individual aperture.

9. The electrical fixture of claim 7, wherein the sheathed cable is NM-B or UF-B.

10. The electrical fixture of claim 7, wherein the plurality of separate indicators comprises three indicators identifying hot, neutral and ground.

11. The electrical fixture of claim 7, wherein the at least one terminal screw comprises a single screw that actuates a clamp on a pivot point to secure the plurality of inserted wires in the least first plurality of apertures.

12. The electrical fixture of claim 7, wherein the at least one terminal screw comprises a plurality of screws, each screw of the plurality associated with a single aperture of the at least one plurality of apertures.

13. The electrical fixture of claim 12, further comprising a separate connection nut in each single aperture connected to it corresponding terminal screw, such that actuation of each terminal screw causes the corresponding connection nut to clamp the inserted wire in the aperture.

14. The electrical fixture of claim 7, further comprising a mounting bracket attached to the body.

15. The electrical fixture of claim 7, wherein the electrical fixture is a 110 volt electrical outlet, a light switch, or a junction box.

16. The electrical fixture of claim 7, wherein the at least first plurality of apertures are disposed on the rear surface of the body.

17. A method of installing a fixture with a quick-connect electrical outlet;
comprising:
stripping the outer sheath of a multi-wire cable at least a first distance from an end to expose the individual wires;
stripping the insulation on the individual wires back at least a second distance from an end to expose the conductive surface;
inserting at least a portion of the exposed conductive surface of each of the individual wires into an individual aperture of at least a first plurality of connection apertures disposed on a body of an electrical fixture at a first position, wherein each aperture is sized and configured to receive a single stripped wire from the sheathed cable and the number of apertures in the first plurality corresponds to the number of individual wires in the sheathed cable, wherein the individual apertures are spaced apart from one another to correspond to the position of individual wires in the sheathed cable, such that the stripped individual wires are inserted without splaying;
actuating at least one terminal screw to secure at least one inserted stripped wire in an aperture of the first plurality, such that inserted wire is retained in the aperture in conductive contact with an electrical track in the body.

18. The method of claim 17, wherein inserting at least a portion of the exposed conductive surface of each of the individual wires into an individual aperture of at least a first plurality of connection apertures comprises inserting at least a portion of the exposed conductive surface of each of the individual wires into individual apertures that are designated by a plurality of separate indicators disposed on the body to identify which individual wire from the sheathed cable should be inserted into the identified individual apertures.

19. The method of claim 17, wherein electrical fixture of claim 7, wherein actuating at least one terminal screw to secure at least one inserted stripped wire in an aperture of the first plurality comprises actuating a single screw that actuates a clamp on a pivot point to secure the plurality of inserted wires in the least first plurality of apertures.

20. The method of claim 17, wherein stripping the outer sheath of a multi-wire cable comprises stripping the outer sheath of a NM-B cable.
